(19) United States
(12) Patent Application Publication
(10) Pub. No.: US 2023/0258493 A1
(43) Pub. Date: Aug. 17, 2023

(54) BOTTLE WEIGHING SCALE

(71) Applicant: Testo SE & Co. KGaA, Titisee-Neustadt (DE)

(72) Inventors: Dirk GÖPFERT, Ihringen (DE); Andreas Derr, Donaueschingen (DE)

(73) Assignee: Testo SE & Co. KGaA, Titisee-Neustadt (DE)

(21) Appl. No.: 18/168,742

(22) Filed: Feb. 14, 2023

(30) Foreign Application Priority Data
Feb. 15, 2022 (DE) 102022103557.3

(51) Int. Cl. G01G 21/28; G01G 21/22

(52) U.S. Cl. CPC G01G 21/28; G01G 21/22

(57) ABSTRACT

A bottle weighing scale having an upper part (2) on which a support face (4) for an item to be weighed is configured, and a lower part (3) on which at least one foot (5) is configured. A determination of weight takes place by a change in the position between the upper part (2) and the lower part (3). The support face (4) of the bottle weighing scale (1) is smaller than a footprint area (6) defined by the at least one foot (5).

### CROSS-REFERENCE TO RELATED APPLICATIONS

This application claims priority from German Patent Application No. 10 2022 103 557.3, filed Feb. 15, 2022, which is incorporated herein by reference as if fully set forth.

### TECHNICAL FIELD

The invention describes a bottle weighing scale having an upper part on which a support face for an item to be weighed is configured, and a lower part on which at least one foot is configured, a determination of weight taking place by a change of the position between the upper part and the lower part.

### BACKGROUND

Such weighing scales are used, for example, for weighing bottles, for example refrigerant or gas bottles. This take place in the field, for example, thus upon delivery, for instance, and not in a controlled environment. In the process, measuring errors may arise as a result of rocks on the ground, for example, or other uneven surfaces.

### SUMMARY

The object of the invention is to achieve a weighing scale which offers simpler handling, in particular in the field.

This object is achieved by a weighing scale having one or more of the features disclosed herein.

Accordingly, the weighing scale according to the invention is characterized in that the support face is smaller than the footprint area defined by the at least one foot. In this way, heavy bottles (approx. 100 kg) can be rolled onto the weighing scale instead of said bottles being lifted onto the weighing scale with a great effort in terms of force. When the bottle is being rolled onto the weighing scale, the bottle initially contacts the lateral edge of the weighing scale.

As a result of the footprint area being larger than the bearing face, the bearing feet lie in front of this edge. A force vector which acts on the edge by way of the bottle, is absorbed by the feet, as a result of which the footing of the weighing scale is additionally stabilized. As a result, tilting or shifting of the weighing scale is reliably prevented.

In one embodiment, at least two, in particular four, feet are configured, each foot having in particular a dedicated weight sensor. A safe footing can be guaranteed in this way.

In one embodiment, the support face is formed by a rectilinear connection of outer delimitations of neighboring feet. Created as a result is a substantially rectangular or square contour which defines a safe footprint area.

In one embodiment, a perpendicular projection of the support face onto the footprint area at least in one contour portion of the support face, in particular along the full contour, lies within the footprint area, a minimum spacing between a periphery of the footprint area and a periphery of the support face being maintained in particular. Simple handling of the weighing scale is possible in this way because, as has been described above, a bottle can be rolled on at a plurality of locations without the risk of tilting.

In one embodiment, the lower part in the lateral direction is at least the size of the upper part, a contour element, which is preferably spaced apart from a position of a floor defined by the at least one foot and which replicates a contour of the upper part at a specific height, being in particular configured on the lower part. The risk of the upper part bearing on an uneven surface can be minimized or eliminated in this way. This is in particular helpful during the use outdoors because no adequate ground clearance is ensured there and small rocks or other objects bear on the upper part, thus potentially influencing the measurement result. In this way, rocks or uneven surfaces can no longer contact the upper side and impede a weighing movement.

In the embodiment according to the invention, small rocks and objects instead bear on the contour element which can be configured as a rib, for example, or a projecting edge. In addition, the use in unpaved terrain is improved as a result of the contour element. In this way it is possible even when the bearing feet sink in soft ground that contact with the upper part is prevented by the contour element, and incorrect measurements are thus avoided.

In one embodiment, a preferably concentric contour in the shape of a circular segment is formed on the upper part at least in one segment between two neighboring feet. In this way it is easier for a bottle to be centrically aligned on the bearing face.

As a result, it is possible to identify, despite a one-sided viewing perspective, whether the one bottle is centrically positioned, for example, because concentric deviations in relation to the circular shapes on the weighing scale are more obvious. This is particularly helpful when lifting a heavy bottle onto the weighing scale, because the viewing perspective in this movement is one-sided and subsequent centering by displacing the bottle is required in commercially available weighing scales. In contrast, in the embodiment according to the invention a bottle can be reliably centered already during the movement of placing the latter.

In one embodiment, a carrying handle is configured, in particular by the contour in the shape of a circular segment, on the upper part. Easy transportation of the weighing scale is made possible in this way, for example without a transport case.

In one embodiment, a lateral step, in particular a taper, is disposed between at least two neighboring feet. This step is in particular aligned toward the support face. Rolling a bottle onto the weighing scale can in particular be simplified in this way. Moreover, the step or the ramp minimizes the force vector perpendicular to the floor such that the risk of tilting the weighing scale is additionally reduced.

In one embodiment, the lower part and/or the upper part between at least two neighboring feet are/is configured so as to be concave. As a result, it can be achieved that the bearing face, at least between the feet, is smaller than the footprint area, on the one hand. On the other hand, a step or taper may lie in this concave region, as a result of which rolling a bottle is simplified.

In one embodiment, an electronic evaluation unit is disposed in the upper part. In this way, the lower part can be of an ideally low configuration, as a result of which the stability can be additionally increased.

The invention also comprises the use of a bottle weighing scale, in particular as claimed in one of the preceding claims, for weighing a fluid-containing bottle, wherein the bottle, when placed so as to be centric, laterally protrudes a support face on at least two, in particular on four, sides.

### BRIEF DESCRIPTION OF THE DRAWINGS

The invention is explained in more detail hereunder by means of an exemplary embodiment with reference to the appended drawings.

In the drawings:

FIG. 1: shows an oblique view of a weighing scale according to the invention;

FIG. 2: shows a view of the weighing scale of FIG. 1 from below;

FIG. 3: shows a lateral view of the weighing scale of FIG. 1;

FIG. 4: shows an enlargement of a detail of FIG. 4;

FIG. 5: shows a plan view of the weighing scale of FIG. 1, having plotted circles; and

FIG. 6: shows the plan view of the weighing scale of FIG. 1, having a plotted bearing face and footprint area.

### DETAILED DESCRIPTION

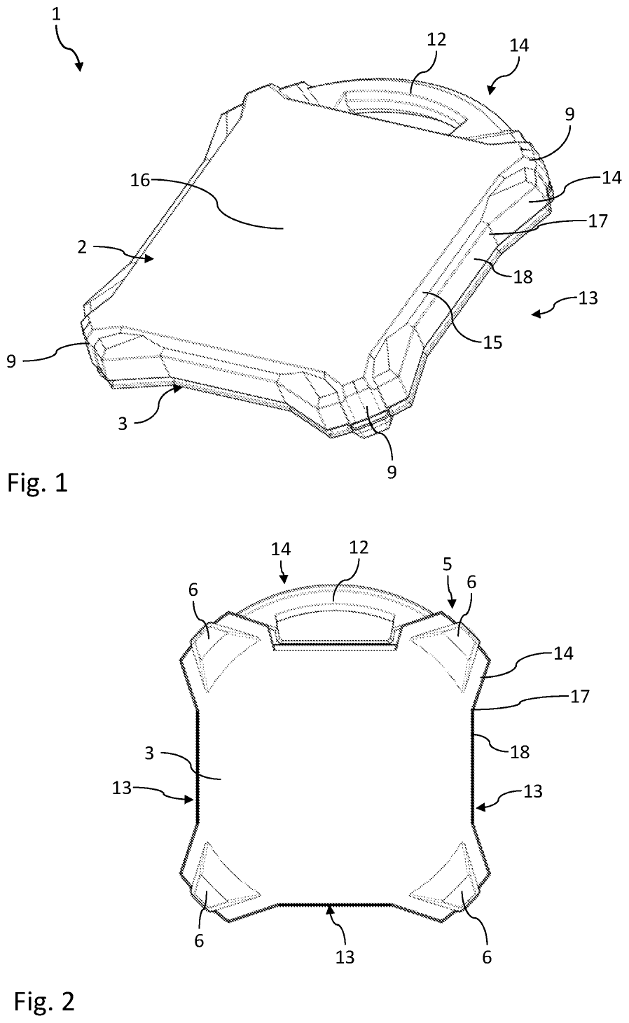

FIG. 1 shows a bottle weighing scale 1 according to the invention, having an upper part 2 and a lower part 3. The upper part 2 has a bearing face 4 on which an item to be weighed, in particular a bottle, is able to be deposited.

The upper part 2 and the lower part 3 are movable relative to each other perpendicularly to the bearing face 4. A determination of the weight force of the item to be weighed is possible by way of the deflection or relative movement.

Weighing scale electronics (not shown) are disposed in the upper part 2. In this way, the lower part 3 can be configured so as to be very flat.

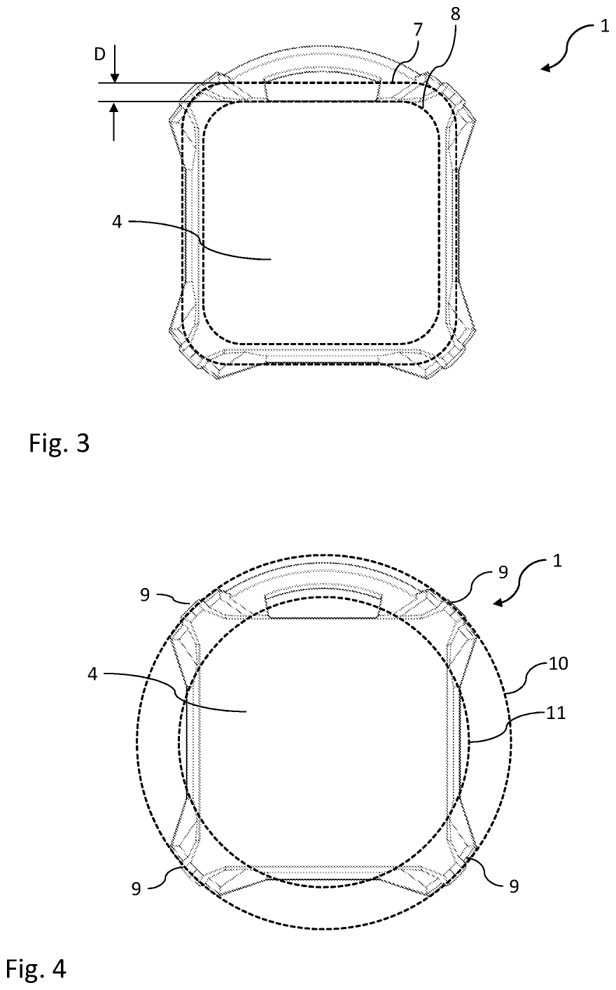

FIG. 2 shows a view from below of the bottle weighing scale 1. The bottle weighing scale 1 in the example possesses four feet 5, the rectilinear connection of the outer delimitations thereof defining the footprint area 6 of the bottle weighing scale 1. Shown in FIG. 3 is the footprint area 6 in relation to the projection of the bearing face 4. The contour 7 of the footprint area 6 has a spacing D from the contour 8 of the bearing face 4, the spacing D being almost constant across the circumference of the contour in the example. Overall, it may be expedient for the spacing D to have a minimum spacing which is a function, inter alia, of the spacings between the feet and/or the height of the weighing scale. For example the spacing D can be between 1 cm and 2 cm.

As a result, a contact point or contact face between a bottle which is to be rolled onto the weighing scale and the bearing face 4 always lies within the contour 7 of the footprint area 6. It is prevented as a result that the bottle weighing scale 1 tilts, for example when a bottle stands on the bearing face 4 so as not to be exactly centered on the latter, or while a bottle is being rolled onto the bottle weighing scale 1.

The feet 5 toward the outside have a contour 9 in the shape of a circular segment and are disposed such that these circular segments 9 form a first circle 10, as is shown in FIG. 4. The bottle weighing scale 1 is configured so as to be concave on three sides between the feet 5. In the example, the concave sides 13 are formed by a straight side 18 which is in each case connected to neighboring feet 5 by ramps 14.

The corners 17 between the ramps 14 and the straight sides 18 conjointly form a second circle 11 which lies to as to be concentric within the first circle 10. As a result, the two circles 10 and 11 can be clearly seen on the bottle weighing scale 1 and simplify centering of a round bottle on the bearing face 4.

As a result, it is possible, despite a one-sided viewing perspective, to identify whether a round bottle is disposed so as to be centrically positioned on the bottle weighing scale 1, because concentric deviations from the circular shapes 10, 11 on the bottle weighing scale 1 are more obvious than from angular structures. This is particularly helpful when lifting a heavy bottle onto the bottle weighing scale 1, because the viewing perspective is one-sided during this movement and subsequent centering by displacing the bottle is required in commercially available weighing scales. In contrast, in the embodiment according to the invention a bottle can be reliably centered already during the movement of placing the latter.

The bottle weighing scale 1 on the non-concave side 14 has a carrying handle 12 which is configured so as to be convex between two neighboring feet 5 and runs substantially along the first circle 10. The carrying handle 12 enables the bottle weighing scale 1 to be easily received and easily transported, even without an additional transport case.

Overall, an X-shaped characteristic of the bottle weighing scale 1 is derived as a result of the disposal of the feet 5. This enables a significantly larger bearing face 4 and, despite a small construction mode, leads to a very stable footing. This is very advantageous in particular in the case of heavy bottles and uneven terrain.

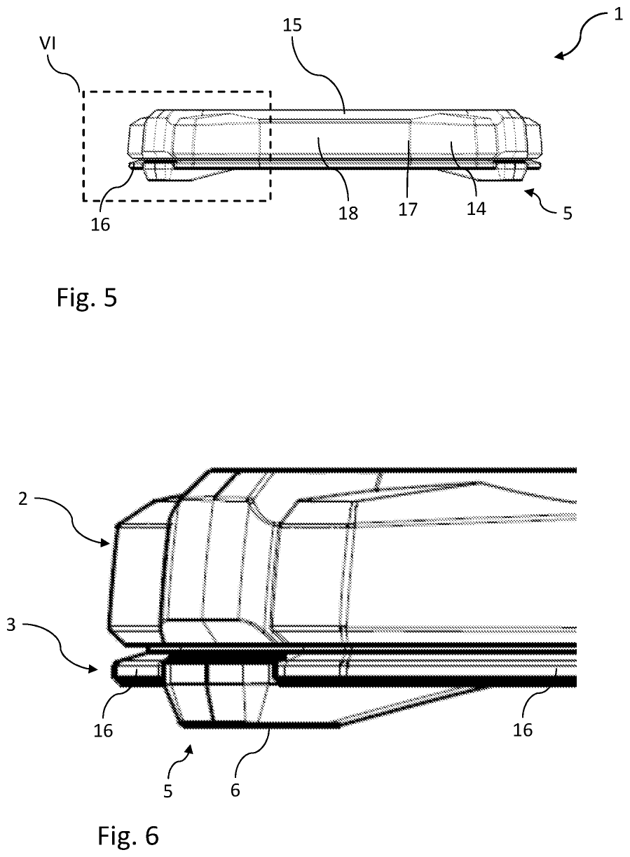

FIG. 5 shows a lateral view of the bottle weighing scale 1. The upper side 2 of the bottle weighing scale 1, on the concave sides 13, toward the bearing face 4 has in each case a taper 15 or a step. The obstacle for rolling a bottle onto the weighing scale is reduced as a result.

The lower side 3 of the bottle weighing scale 1 has a contour element 16 which is spaced apart from the floor and replicates a contour of the upper part 2 at a specific height. The contour element 16 has the shape of an edge or rib, as is shown in detail in FIG. 6.

The contour element 16 minimizes the risk of the upper part being able to bear on a surface unevenness. This is particular helpful during the use outdoors because no adequate ground clearance is ensured there and small rocks or other objects bear on the upper part 2, thus potentially influencing the measurement result. In the embodiment according to the invention, small rocks and objects bear on this contour element 16. The contact between rocks or unevenness and the upper part 2, and thus the influencing of the measurement result, is thus prevented. In addition, the use in unpaved terrain is improved as a result of the contour element. In this way, it is possible that contact with the upper part 2 is prevented by way of the contour element and measuring errors are thus avoided, even when the bearing feet sink into soft ground.

### LIST OF REFERENCE SIGNS

1 Weighing scale
2 Upper part
3 Lower part
4 Bearing face
5 Foot
6 Footprint area
7 Contour of the footprint area
8 Contour of the bearing face
9 Circular segments
10 First circle
11 Second circle
12 Carrying handle
14 Ramp
15 Taper
16 Contour element
17 Corner
18 Straight side

1. A bottle weighing scale, comprising:
an upper part (2) on which a support face (4) for an item to be weighed is configured;
a lower part (3) on which at least one foot (5) is configured, a determination of weight taking place by a change of the position between the upper part (2) and the lower part (3); and
the support face (4) is smaller than a footprint area (6) defined by the at least one foot (5).

2. The bottle weighing scale as claimed in claim 1, wherein the at least one foot comprises at least two said feet (5), and each said foot (5) includes a dedicated weight sensor.

3. The bottle weighing scale as claimed claim 2, wherein the footprint area (6) is formed by a rectilinear connection of outer delimitations of adjacent ones of said feet (5).

4. The bottle weighing scale as claimed in claim 1, wherein a perpendicular projection (7) of the support face (4) onto the footprint area (6) at least in one contour portion of the support face (4), lies within the footprint area (6), and a minimum spacing between a contour (7) of the footprint area (6) and a contour (8) of the support face (4) is maintained.

5. The bottle weighing scale as claimed in claim 1, wherein the lower part (3) in a lateral direction has a size that is at least as great as a size of the upper part (2), and a contour element (16) that is configured to be spaced apart from a position of a floor defined by the at least one foot, replicates a contour of the upper part (2) at a specific height.

6. The bottle weighing scale as claimed in claim 2, wherein a contour (10, 11) having a shape of a circular segment is formed on the upper part (2) at least in one segment between two neighboring ones of the feet (5).

7. The bottle weighing scale as claimed in claim 2, wherein at least one of the lower part (3) or the upper part (2) is configured to be concave between at least two neighboring ones of the feet (5).

8. The bottle weighing scale as claimed in claim 1, further comprising a carrying handle (12) configured on the upper part (2).

9. The bottle weighing scale as claimed in claim 8, wherein the carrying handle (12) is configured with a contour (10) shaped as a circular segment.

10. The bottle weighing scale as claimed in claim 1, further comprising a lateral step disposed between at least two neighboring ones of the feet (5) in the upper part (2).

11. The bottle weighing scale as claimed in claim 1, further comprising an electronic evaluation unit is disposed in the upper part (2).

12. A method of weighing a fluid-containing bottle, the method comprising:
providing the bottle weighing scale as claimed in claim 1; and
placing the fluid-containing bottle so as to be centric, and laterally protruding over the support face on at least two sides for weighing the fluid-containing bottle.
